(19) United States
(12) Patent Application Publication
(10) Pub. No.: US 2014/0020823 A1
(43) Pub. Date: Jan. 23, 2014

(54) METHOD FOR ATTACHING A PRE-SINTERED BODY OF ULTRAHARD MATERIAL TO A SUBSTRATE

(71) Applicant: ELEMENT SIX ABRASIVES, S.A., (US)

(72) Inventor: Charles Stephan Montross, Gauteng (ZA)

(73) Assignee: ELEMENT SIX ABRASIVES, S.A., Luxembourg (LU)

(21) Appl. No.: 13/718,223

(22) Filed: Dec. 18, 2012

Related U.S. Application Data
(60) Provisional application No. 61/580,865, filed on Dec. 28, 2011.

(30) Foreign Application Priority Data
Dec. 28, 2011 (GB) 1122384.9

(51) Int. Cl. B23K 31/02

(52) U.S. Cl. CPC B23K 31/02
USPC 156/272.2; 228/121

(57) ABSTRACT

A method of attaching a body of superhard material to a substrate comprises placing a layer of a first brazing material on or over at least a portion of a surface of the substrate; the first brazing material having an associated melting temperature. A second brazing material is located between the first brazing material and a face of a pre-formed body of superhard material to form an assembly; the second brazing material having an associated melting temperature lower than the melting temperature of the first brazing material. The assembly is heated to a temperature sufficient to melt the second brazing material and bond the second brazing material to the superhard material and to the first brazing material. The heating temperature is then reduced to a temperature below the melting point of the second brazing material for a period of time to diffuse the second brazing material into the first brazing material to form a brazing mixture having a melting point greater than the melting point of the first brazing material and to form a bonded assembly of the superhard material and the substrate.

### FIELD

This disclosure relates to a method for attaching a pre-sintered body of ultrahard material such as polycrystalline diamond material to a substrate to form a compact for use as, for example, a cutting element in applications such as rock drilling and other operations which require the high abrasion resistance or wear resistance of a surface such as a diamond surface.

### BACKGROUND

One type of conventional cutting element used in rotary drilling operations in earth formations comprises an abrasive composite mounted on a substrate. The composite typically comprises a body of sintered polycrystalline diamond material adhered to a cemented carbide substrate, such as cemented tungsten carbide, and containing a metal binder such as cobalt. Cutter inserts for machining and other tools also may comprise a body of polycrystalline diamond (PCD) bonded to a cemented carbide substrate. PCD is an example of a superhard material, also called superabrasive material, which has a hardness value substantially greater than that of cemented tungsten carbide.

Components comprising PCD material are used in a wide variety of tools for cutting, machining, drilling or degrading hard or abrasive materials such as rock, metal, ceramics, composites and wood-containing materials. PCD comprises a mass of substantially inter-grown diamond grains forming a skeletal mass, which defines interstices between the diamond grains. PCD material comprises at least about 80 volume % of diamond and may be made by subjecting an aggregated mass of diamond grains to an ultra-high pressure of greater than about 5 GPa, typically about 5.5 GPa or greater, and a temperature of at least about 1200° C., typically about 1440° C., in the presence of a sintering aid, also referred to as a catalyst material for diamond. A catalyst material for diamond is understood to be material that is capable of promoting direct inter-growth of diamond grains at a pressure and temperature condition at which diamond is thermodynamically more stable than graphite. Some catalyst materials for diamond may promote the conversion of diamond to graphite at ambient pressure, particularly at elevated temperatures. Examples of catalyst materials for diamond are cobalt, iron, nickel and certain alloys including any of these. PCD may be formed on a cobalt-cemented tungsten carbide substrate, which may provide a source of cobalt catalyst material for the PCD, the metal binder/catalyst from the cemented carbide substrate sweeping from the substrate through the diamond grains to promote sintering of the diamond grains. As a result, the diamond grains become bonded to each other to form a polycrystalline diamond layer and the diamond layer becomes bonded to the substrate. The interstices within PCD material may at least partly be filled with the catalyst material.

One of the factors limiting the success of the polycrystalline diamond (PCD) abrasive cutters is the generation of heat due to friction between the PCD and the work material. This heat causes thermal degradation of the diamond layer. Thermal degradation causes damage to the PCD through two mechanisms. Firstly, differential thermal expansion between the binder, which is also known as a solvent-catalyst material, and the bonded diamond crystals can cause the diamond-to-diamond bonding to rupture. Such differential thermal expansion is known to occur at temperatures of more than about 400° C. Secondly, the solvent metal catalyst can cause undesired catalysed phase transformation changing the diamond back to a graphitic or amorphous form limiting the practical use of the PCD material to a temperature of about 750° C.

One known technique to improve the thermal stability of the PCD material involves removing the sintered PCD layer from the substrate, subjecting the PCD layer to a suitable process for removing the solvent-catalyst material, such as acid-leaching, and subsequently re-attaching it to the substrate. The PCD with solvent-catalyst removed has good thermal stability and is commonly referred to as a thermally stable polycrystalline diamond (TSP). This process extends the useful cutting life of a cutting tool incorporating TSP as the cutting element. However, a problem known to exist with such TSP is that it is difficult to achieve a good re-attachment of the TSP to a substrate that can then be fabricated into a tool. The reason for this is that, typically, PCD compacts are brazed into a tool body for use, for example, in a drill bit for drilling in subterranean formations. Despite careful controls, peak temperatures can often reach 900° C. for short periods of time during this attachment step. If a conventional braze is used to attach the TSP to the substrate forming the abrasive PCD compact cutting element, when the abrasive compact is brazed to the tool the heat from the brazing process may soften the bond between the TSP and the substrate causing the TSP to become loose and move out of alignment.

To solve this problem, higher temperature brazes to bond the PCD tables to their carbide substrates have been tried. However, to protect the temperature sensitive PCD tables, short braze times are typically attempted. This often results in poor bonding and poor assembly. Use of longer times is again problematic, for example the accumulated thermal damage acquired by repeated heating to 900° C. tends to degrade the PCD tables.

In other conventional techniques, the process of attaching the TSP to a substrate is typically performed at high pressure and high temperature (HPHT) where diamond is thermodynamically stable and where the temperature is high enough to achieve bonding between the TSP and the substrate. This thereby renders the reattachment process an expensive process.

Other solutions that have been proposed to attach a cemented carbide substrate to a TSP body include to re-infiltrate the TSP body with the cobalt from the substrate or to place an additional layer of cobalt at the interface between the substrate and TSP body and subject it to a thermal cycle. The problem with these methods is that the cobalt requires a high temperature to melt and infiltrate the interstices between the diamond grains forming the TSP body. The temperature required to melt the cobalt is around 1300° C. and, at this temperature at ambient pressure, diamond is unstable in the presence of cobalt. The cobalt causes graphitisation of the TSP body and introduces thermal damage. However, if an HPHT cycle is used to maintain the TSP in the diamond stable region at the high temperatures when bonding the TSP to the substrate, high costs are incurred.

Furthermore, as TSP compacts are essentially composed only of diamond, they are difficult to bond to supports, formed for example of a ceramic/cemented tungsten carbide. One known technique is to wet the TSP using a standard braze alloy. However, diamond is very difficult to wet due to the differences in electronic structure between the diamond material and metals, resulting in the molten metal alloys not wetting the diamond material. This further illustrates that the attachment of diamond to a variety of substrates is difficult. Also, too thick a wetting layer on the diamond/ceramic substrate surface and the interface therebetween becomes brittle.

To enhance the wetting of the diamond material by the braze alloy, braze alloys commonly known as Active Braze Alloys may be used. They work through the active reaction of the carbide (or nitride) forming metals with the diamond material to form a carbide (or nitride) film which the standard braze metals can then wet. However, a difficulty with the use of Active Braze Alloys is they require very low oxygen partial pressures, down to approximately 10-6 torr, to prevent the oxidation and resultant loss of the active metal in the alloy which would require specialized equipment which is both expensive and requires specialized operation. Another issue is the possibility of hydrogen embrittlement when furnaces are used with mixtures of inert gas and hydrogen gas to prevent oxidation.

There is a need to overcome or substantially ameliorate the above-mentioned problems through a bonding technique for bonding a body of PCD material to a substrate.

### SUMMARY

Viewed from a first aspect there is provided a method of attaching a body of superhard material to a substrate comprising:
placing a layer of a first brazing material on or over at least a portion of a surface of the substrate; the first brazing material having an associated melting temperature;
locating a second brazing material between the first brazing material and a face of a pre-formed body of superhard material to form an assembly; the second brazing material having an associated melting temperature lower than the melting temperature of the first brazing material;
heating the assembly to a temperature sufficient to melt the second brazing material and bond the second brazing material to the superhard material and to the first brazing material; and
reducing the heating temperature to a temperature below the melting point of the second brazing material for a period of time to diffuse the second brazing material into the first brazing material to form a brazing mixture having a melting point greater than the melting point of the first brazing material and to form a bonded assembly of the superhard material and the substrate.

In some embodiments, the superhard material is polycrystalline diamond material and, prior to the step of locating the second brazing material, the method further comprises removing solvent-catalyst material from interstices of the body of polycrystalline diamond material, for example from the interstices of at least a portion of the body of PCD material.

### BRIEF DESCRIPTION OF THE DRAWINGS

Some embodiments will now be described by way of example only and with reference to the accompanying drawings in which:

FIG. 1 is a schematic diagram of an embodiment method;

FIG. 2 is a phase diagram for Ag—Cu;

FIG. 3 is a schematic diagram of a further embodiment method;

FIG. 4 is a phase diagram for Au—Ni; and

FIGS. 5 to 11 are schematic diagrams of further embodiment methods.

In the following description, corresponding components have been denoted by the same reference numerals.

### DETAILED DESCRIPTION OF EMBODIMENTS

As used herein, “polycrystalline diamond” (PCD) material comprises a mass of diamond grains, a substantial portion of which are directly inter-bonded with each other and in which the content of diamond is at least about 80 volume percent of the material. In one embodiment of PCD material, interstices between the diamond grains may at least partly be filled with a binder material.

As used herein, “catalyst material for diamond” is a material that catalyses intergrowth of polycrystalline diamond particles or grains under conditions of temperature and pressure at which diamond is more thermodynamically stable than graphite.

As used herein, “interstices” or “interstitial regions” are regions between the diamond grains of PCD material.

As used herein, a “green body” is an article that is intended to be sintered or which has been partially sintered, but which has not yet been fully sintered to form an end product. It may generally be self-supporting and may have the general form of the intended finished article.

An abrasive composite is formed in the conventional manner by, for example, by subjecting an aggregated mass of diamond grains to an ultra-high pressure of greater than about 5 GPa, typically about 5.5 GPa or more, and temperature of at least about 1200° C., typically about 1440° C., in the presence of a sintering aid, also referred to as a catalyst material for diamond. Examples of catalyst materials for diamond are cobalt, iron, nickel and certain alloys including any of these. The PCD may be formed on a cobalt-cemented tungsten carbide substrate, which may provide a source of cobalt catalyst material for the PCD, the metal binder/catalyst from the cemented carbide substrate sweeping from the substrate through the diamond grains to promote sintering of the diamond grains. The diamond grains become bonded to each other to form a body of polycrystalline diamond which becomes bonded to the substrate along an interface. The interstices within body of PCD material may at least partly be filled with the catalyst material.

To increase the thermal stability of the body of PCD material after sintering, the body of PCD material is subjected to a conventional process for removing the solvent-catalyst material from the interstices. Examples of such conventional processes include chemical treatments, for example acid leaching or aqua regia bath, an electrochemical technique such as an electrolytic process, a liquid metal solubility technique, or a liquid metal infiltration technique, or combinations of one or more of these or other known processes. The removal of the catalyst material from the interstices of the at least a portion of the body of PCD material may be to a selected depth from an exterior of the PCD body, or, in some embodiments, the entire PCD body may be subjected to the leaching process causing substantially all of the original catalyst material to be removed from the interstices leaving voids between the diamond grains. As known in the art, at least partial catalyst removal from the PCD may provide a body of PCD material with increased thermal stability and such PCD material is commonly referred to as thermally stable polycrystalline diamond (TSP). This may also beneficially affect the wear resistance of the PCD material in use.

In some embodiments, the solvent-catalyst material may be removed from all or a desired region of the body of PCD material by an acid leaching technique such as that described, for example, in the applicants' co-pending GB patent application published as GB 2465175 or another known technique such as that described, for example in U.S. Pat. No. 4,224,380.

Either prior to the removal of the solvent-catalyst or after subjecting the body of PCD material to the above-described treatment to remove the solvent-catalyst, the body of PCD material is removed from the substrate on which it was formed by, for example, a cutting process. The PCD material then needs to be re-attached to a substrate to form a PCD compact element for use in, for example, a cutting tool.

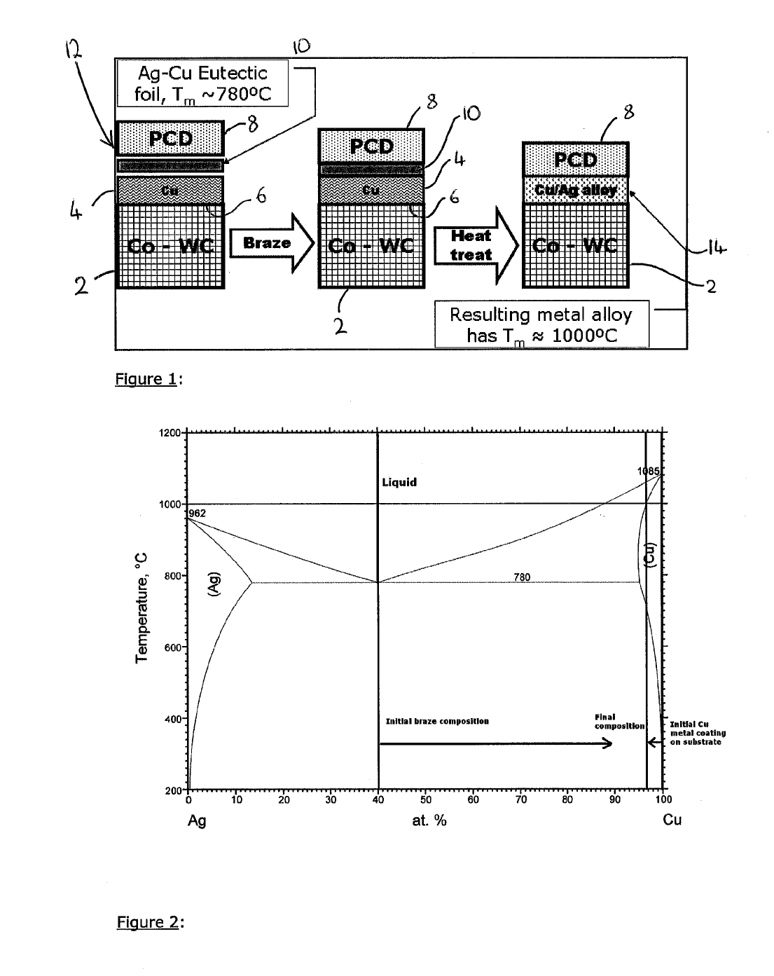

A first embodiment is illustrated by the schematic diagram of FIG. 1 which shows a cutting element composite comprising a cemented carbide substrate 2 onto which a thermally stable body of PCD material 8 is to be placed prior to re-bonding the body of PCD material 8 to the substrate 2. In a first stage, a free surface 6 of the substrate 2 is coated with a thick layer 4 of high melting point metal or braze alloy material. An example of the thickness of the layer 4 is between around 50-100 microns. The substrate 2 may be formed, for example, of tungsten carbide with a cobalt binder therein, and the high melting point metal or braze alloy 4 may include, for example, Cu or Ni and/or may be, for example a Cu Active Braze Alloy (ABA). In this embodiment, the metal/braze alloy 4 is bonded to the free surface 6 of the substrate 2 to which the pre-sintered PCD body 8 is to be attached.

A thin layer 10 of lower melting point braze material is placed on top of the high melting point layer 4. The thickness of the layer 10 of lower melting point braze material may be, for example, less than around 50 microns. An example of the low melting point braze material 10 is a Ag—Cu eutectic Active Braze Alloy (ABA) which has a melting point of approximately 780° C. The lower melting point braze material may be, for example, in the form of a layer or foil. The pre-sintered body of PCD material 8 is then placed on top of the low melting point braze layer 10, as shown in FIG. 1. This forms the starting assembly 12.

The starting assembly 12 is then heated, for example in a furnace, to a temperature which is sufficient to melt the low melting point braze material 10 thus allowing it to bond to both the PCD table 8 and the high melting point layer 4 on the substrate 2. In the example where the low melting point braze material comprises a Ag—Cu ABA, a temperature of at least around 800° C. should be sufficient to melt the Cu—Ag eutectic ABA layer 10 and allow it to bond to the body of PCD material 8 and also to the Cu ABA braze layer 4, as shown in the middle diagram of FIG. 1. With this heat treatment, the Ag—Cu eutectic Active Braze Alloy 10 disappears as a separate entity as the silver diffuses into the bulk of the copper, as shown on the right hand side drawing of FIG. 1.

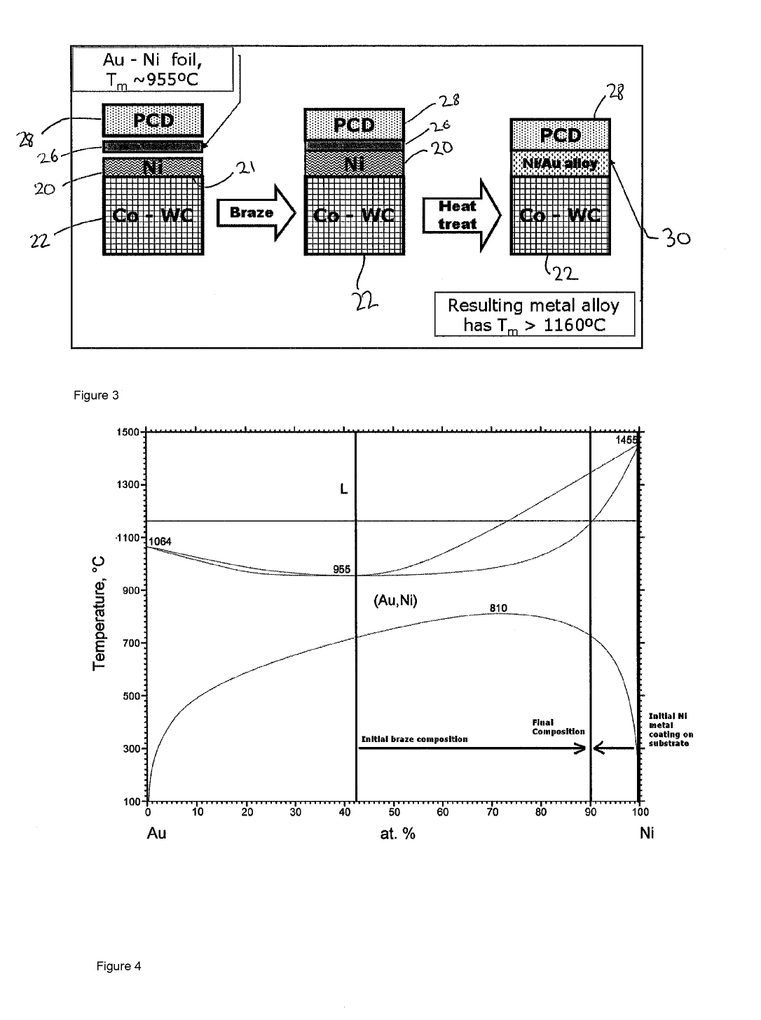

In FIG. 2, the Ag—Cu phase diagram (ASM 900017) is shown. In this figure, the two outer vertical lines indicate the initial compositions of the Ag—Cu eutectic braze (left) and the Cu coating (right).

After the assembly has been heated and brazed together, the assembly is then cooled to a temperature, such as around or below 600° C., and held for a period of time which is sufficient to allow the elements in the low melting point ABA braze layer 10 to diffuse into the high melting point braze layer 4 and approach equilibrium. An example of such a time is 3 to 10 seconds. In the embodiment of FIG. 1, this time period allows the silver elements in the Ag—Cu eutectic braze layer 10 to diffuse into the Cu ABA braze layer 4 and approach an equilibrium composition. This behaviour is shown in FIG. 2 by the arrows from the two outer vertical lines approaching the equilibrium composition shown by the middle vertical line. The outer line on the right side of the figure corresponds to 100 atomic % Cu.

The end product is comprised of the Co—WC substrate 2 to which the body of PCD material 8 is bonded through a CU/Ag alloy layer 14 therebetween and the result is that the melting point of the new braze layer 14 bonding the PCD material 8 to the carbide substrate 2 increases significantly. For the case of Cu—Ag eutectic ABA 10 with a Cu layer 4 on the carbide substrate 2, indications are that the resulting melting point of the new braze layer 14, which is a Cu/Ag alloy layer, will be in the region of about 1000° C.

In some embodiments, the overall composition may comprise 97 atomic % Cu (approximately 95 wt %) and 3 atomic % Ag (approximately 5 wt %), in which case the resulting melting temperature of the new braze layer 14 is approximately 1000° C. This is shown by the upper horizontal line in FIG. 2.

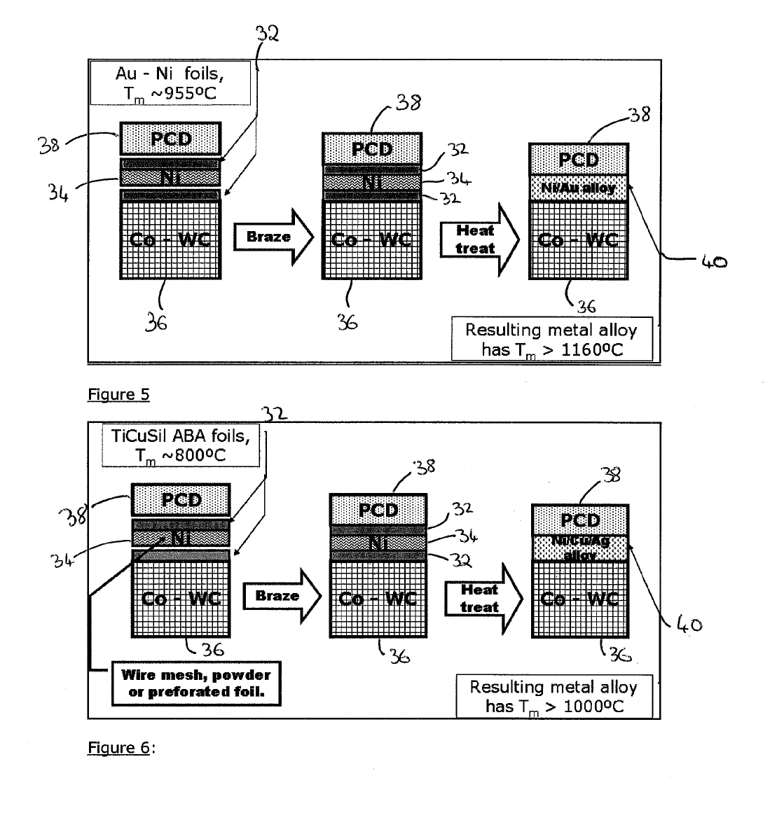

A further embodiment is illustrated by the schematic diagram in FIG. 3 which shows a high melting point Ni layer 20 coating a free surface 21 of a substrate 22 with a low melting point Au—Ni eutectic braze alloy layer 26 being placed between the Ni layer 20 and a surface of the PCD layer 28 to be attached to the substrate 22 as shown in the left hand portion of FIG. 3. The PCD table 28, Au—Ni eutectic braze alloy 26, and Ni coated substrate 22 are brazed together, as shown in the middle portion of FIG. 3. After heat treatment, the Au from the Au—Ni layer 26 diffuses into the bulk Ni coating 20 on the substrate 22 resulting in a homogeneous metal layer 30, as shown in the right hand side of FIG. 3. The metal layer 30 has a melting temperature of approximately 955° C. and a composition of 57.5 atomic % Au (approximately 82 wt %) and 42.5 atomic % Ni (approximately 18 wt %) and is shown as the left vertical line in the Au—Ni phase diagramⁱ (ASM 900236) of FIG. 4. In this diagram the Ni coating is shown as a vertical line at the 100% Ni composition.

An example in this embodiment of overall composition may be 90 atomic % Ni (approximately 73 wt %) and 10 atomic % Au (approximately 27 wt %), which may result in the melting temperature of the new layer of brazing material 30 being approximately 1160° C. as deduced from the middle vertical and the horizontal lines in FIG. 4. The arrows from the outer vertical lines show how the composition will shift as the overall composition approaches equilibrium at the middle vertical line.

A further embodiment is illustrated by FIG. 5 in which an assembly is prepared consisting of two low melting point braze foils or layers 32 placed one on either side of a layer of higher melting point braze or metal alloy 34. The above assembly of layers 32, 34 is placed between the substrate 36 and the PCD body 38. The assembled component is then subjected to the heat treatments described above with respect to the earlier described embodiments and a and has the advantage of eliminating the need for preliminary bonding of a high temperature metal to the substrate 36. Example embodiments include all material combinations as recited in the single-layer embodiments described with respect to FIGS. 1 to 4.

The further embodiment illustrated in FIG. 6 differs from that of FIG. 5 in that the higher melting point braze material 34 which may be, for example, a coating, or a metal alloy, may be applied as a metal mesh, or a perforated foil, or a compact, or a pre-cast tape, or a fibre preform, or a powder layer or any combination of these. Whilst not wishing to be bound by theory, it is believed that the higher surface area of such a material may allow quicker reaction times and enable homogenization to be approached or reached at a more commercially-viable rate. The possibility of oxidation of the higher surface area material either in handling or during brazing is best addressed by methods including, but not limited to, methods commonly used in industry to manufacture with oxygen sensitive, reactive metals, such as using glove boxes with an inert atmosphere, and high vacuum furnaces.

In a further embodiment, the higher melting point braze material or metal alloy 34 may comprise a low thermal conductivity metal or ceramic materials as illustrated in FIG. 7.

In a related embodiment, a higher melting point braze may be selected for also having a lower thermal conductivity.

The previous two embodiments may enable a thermal barrier layer to be formed which may assist in protecting the PCD table 38 during later brazing of the cutter to the drill bit. Such low thermal conductivity, higher melting point materials 34 may be, for example, in the form of a mesh, or perforated foil, or a fiber preform, or a powder layer or any combination of these.

A still further embodiment is arranged to accommodate differences in thermal expansion coefficients between the PCD table 38 and the substrate 36. The use of heat treatment to remove the low melting point braze 32 may also be used to set up a gradient of metal or alloy composition or concentration resulting in a gradient in thermal expansion. This may be achieved through the judicious selection of braze alloy 32 and substrate coating 34 as well as appropriate heat treatment. The result after brazing and heat treatment is expected to be that there are no identifiable layers in the braze joint.

In a related embodiment a mesh, or perforated foil, or a fiber preform, or a powder layer or any combination of these may also be used to vary the effective thermal expansion coefficient when brazed. These layers may be graded with differing thermal expansion coefficients so that there are no distinct layers in the final braze joint. An advantage of the lack of distinct layers may be the reduction of any potential corrosion and/or electrochemical gradients resulting in degradation of the cutter.

Some embodiments are described in more detail with reference to examples which are not intended to be limiting. The examples are examples of methods for applying the heating to the assemblies to melt the lower melting point brazing layer(s) in the manufacturing of the cutter assemblies.

A first example is to apply the heat using furnace technology which is capable of a high vacuum sufficient to prevent the oxidation of the reactive metal (such as titanium). The reason for this is because, without the reactive metal, the remainder of the braze alloy is unlikely to wet the PCD layer.

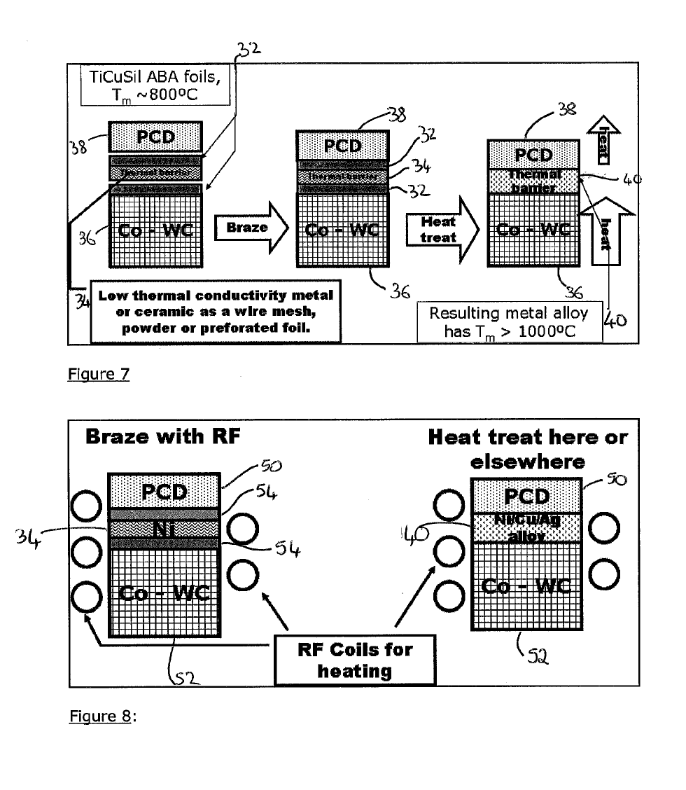

Alternatively, RF and/or induction heating may be used to heat the assemblies, as shown in FIG. 8, where the surface of the body of PCD material 50 to be brazed to the substrate 52 is pre-reacted with a reactive metal such as by coating and heat treatment. The braze operation may be observed and controlled during the rapid heat-up to the melting point of the low temperature braze alloy layer(s) 54. A second step to these methods would be to move the brazed components to a vacuum furnace for further heat treatment and homogenization of the metal alloys.

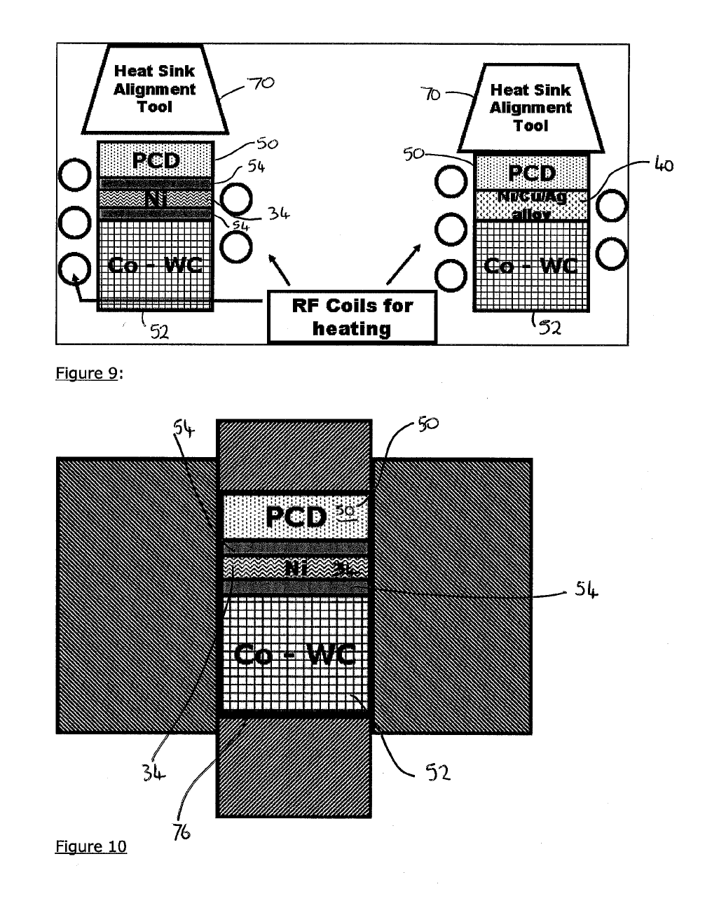

A further method is an extension of either the RF or the induction heating methods and is the use of a device 70 in physical contact with the PCD table 50 to be brazed, as illustrated in FIG. 9. This device 70 may be used to control the temperature of the PCD table 50 during brazing by acting as a heat sink and further may also be useful for applying pressure and positioning the PCD table 50 during the brazing operation. This may be particularly useful in the positioning of non-planar components during the brazing operation.

Another method is the use of a hot press die system similar to the device described in the method above, which is illustrated by FIG. 10. The hot press die system 76 may be suitable for joining large components together which require higher loads than commonly used during brazing. This method may also be useful when using a braze alloy system where the braze is partially molten. Pressure may be used to help ensure an even distribution of braze and partially molten braze and may help prevent movement due to capillary action, such as from uneven heating. An example of this would be use of higher temperature braze alloys where the extra pressure may result in the braze not needing to go the complete liquidus temperature to achieve the braze joint.

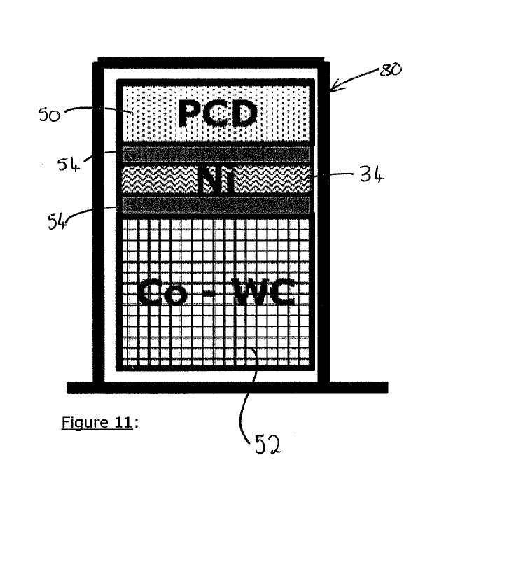

A still further method is the use of a hot isostatic press (HIP) system particularly for mass production of components. The hot isostatic pressing canister(s) 80, as shown in FIG. 11 may be suitable for mass production and a PCD table 50, braze 54, 34, and substrate 52 are readily loaded into each canister 80. The canister(s) 80 would then be heated sufficiently to melt the low temperature braze material 54 and hot isostatically pressed in the HIP system to achieve a braze joint. This method could be followed by a subsequent heat treatment step in an HIP furnace or elsewhere. Apart from large quantities of components being manufactured simultaneously an advantage of this method may be that more complex shapes and combinations of components may be manufactured. Yet another advantage may be that properly set up canisters 80 could protect the braze from oxidation. The hot isostatic press system could furthermore be used when using a braze alloy system where the braze is partially molten. An example of this would be use of higher temperature braze alloys where the extra pressure would result in the braze not needing to go the complete liquidus temperature to achieve the braze joint.

In summary, the joining of thermally stable polycrystalline diamond tables to supporting substrates is a key technology to enabling the use of the thermally stable polycrystalline diamond table properties. An advantage of some embodiments is that it potentially solves/significantly ameliorates the problem of the breakdown of the brazed diamond table/substrate assembly during braze attachment to the drill head in the formation of a cutter for use in drilling/mining applications. In some embodiments, the diamond table is joined to the substrate with a thin layer or layers of lower melting temperature active braze alloy where the substrate has a thicker metal layer of a higher melting temperature attached thereto. This thin active braze alloy layer “disappears” through heat treatment which causes the elements in the thin layer to diffuse and homogenize throughout the thicker brazing layer. The result is an overall increase of the melting temperature of the metal layer which will then withstand the brazing temperatures applied when the cutter is brazed to a drill bit prior to use in mining/drilling applications.

It is expected to be possible to identify via image analysis of a cross-section through a finished cutter, any potential gradients in metals within the resulting braze layer. Also, it is expected that the overall composition will have a melting temperature significantly above commonly used braze alloys based on some of the elements used.

Although particular embodiments have been described and illustrated, it is to be understood that various changes and modifications may be made. For example, braze materials described herein have been identified by way of example as being copper, nickel, or alloys of silver-copper, gold-nickel, or titanium-copper-silicon. It should be understood that other materials or alloys thereof may be used to form the brazing layers.

1. A method of attaching a body of superhard material to a substrate comprising:
placing a layer of a first brazing material on or over at least a portion of a surface of the substrate; the first brazing material having an associated melting temperature;
locating a second brazing material between the first brazing material and a face of a pre-formed body of superhard material to form an assembly; the second brazing material having an associated melting temperature lower than the melting temperature of the first brazing material;
heating the assembly to a temperature sufficient to melt the second brazing material and bond the second brazing material to the superhard material and to the first brazing material; and
reducing the heating temperature to a temperature below the melting point of the second brazing material for a period of time to diffuse the second brazing material into the first brazing material to form a brazing mixture having a melting point greater than the melting point of the first brazing material and to form a bonded assembly of the superhard material and the substrate.

2. A method according to claim 1, wherein the superhard material comprises polycrystalline diamond material.

3. A method according to claim 1, wherein the substrate is formed of cemented carbide and a metal binder phase dispersed therein.

4. A method according to claim 1, wherein the step of placing the layer of a first brazing material comprises bonding the first brazing material to the substrate prior to locating the second brazing material.

5. A method according to claim 1, wherein the step of placing the layer of a first brazing material comprises placing a layer having a thickness of between about 50 to 100 microns of first brazing material on the substrate.

6. A method according to claim 1, wherein the step of locating a second brazing material comprises placing a layer having a thickness of up to about 50 microns of second brazing material.

7. A method according to claim 1, wherein the step of reducing the heating temperature to a temperature below the melting point of the second brazing material for a period of time, comprises reducing the heating temperature for between around 3 to 10 seconds.

8. A method according to claim 1, wherein the step of heating the assembly comprises applying heat using furnace technology capable of high vacuum sufficient to prevent the oxidation of the reactive metal.

9. A method according to claim 1, wherein the step of heating the assembly comprises applying heat using RF and/or induction heating; and/or after the step of forming the bonded assembly, applying further heat using a vacuum furnace to assist in homogenization of the components in the brazing mixture.

10. A method according to claim 9, wherein the step of heating the assembly further comprises placing a device in physical contact with the body of superhard material to be brazed to control the temperature of the superhard material during brazing by acting as a heat sink and/or to apply pressure and aid positioning of the body of superhard material during brazing.

11. A method according to claim 1, wherein the step of heating the assembly comprises applying heat using a hot press die system arranged to apply pressure to assist in an even distribution of braze material.

12. A method according to claim 1, wherein the step of heating the assembly comprises applying heat using a hot isostatic press (HIP) system, the method further comprising placing the body of superhard material, the first and second brazing layers and the substrate in an isostatic pressing canister, and heating the canister to melt the second brazing material.

13. A method according to claim 1, wherein the substrate comprises cemented tungsten carbide.

14. A method according to claim 1, wherein one or other or both steps of placing or locating the first and/or the second layers of brazing materials comprises locating or placing one or other or both of the first and second brazing materials in the form of a layer, a mesh, a foil, a perforated foil, a fiber preform, a coating, a compact, a pre-cast tape, a powder layer or any combination of these.

15. A method according to claim 1, further comprising, prior to the step of locating the second braze material between the first brazing material and the pre-formed body of superhard material, removing solvent-catalyst material from interstices of the body of superhard material.

16. The method of claim 15, wherein the step of removing the solvent-catalyst material comprises removing the solvent-catalyst material from the interstices of at least a portion of the body of superhard material.

17. The method of claim 15, wherein the step of removing the solvent-catalyst material comprises removing the solvent-catalyst material from the interstices of at least a portion of the body of superhard material to a selected depth from an exterior surface of the body of superhard material, or removing the solvent-catalyst material from substantially all of interstices leaving voids between the grains in the body of superhard material.

18. The method of claim 1, wherein the step of placing a layer of first and/or second brazing material comprises placing a layer in the form of a continuous layer.

19. The method of claim 1, wherein the step of placing a layer of first and/or second brazing material comprises placing a discontinuous layer in discrete areas.

20. The method of claim 1, wherein the step of placing a layer of a first brazing material comprises placing a layer comprising one or more of copper, nickel or alloys thereof and/or an active braze alloy thereof.

21. The method of claim 20, wherein the step of heating the assembly to a temperature sufficient to melt the second brazing material comprises heating the assembly to at least around 800 degrees C.

22. The method of claim 20, wherein the step of reducing the heating temperature to a temperature below the melting point of the second brazing material comprises reducing the temperature to around 600 degrees C. or below.

23. The method of claim 20, wherein the step of forming a brazing mixture having a melting point greater than the melting point of the first brazing material, comprises forming a brazing mixture having a melting point of around 1000 degrees C.

24. The method of claim 1, wherein the step of placing a layer of a second brazing material comprises placing a layer comprising one or more of silver, copper, nickel, gold, titanium, silicon or alloys thereof and/or an active braze alloy thereof.

25. The method of claim 1, wherein the step of locating a second brazing material further comprises locating a second layer of the second brazing material between the layer of first brazing material and the substrate prior to the step of locating the layer of first brazing material.

26. The method of claim 25, wherein the second brazing material comprises an Au—Ni alloy.

27. The method of claim 25, wherein the second brazing material comprises a TiCuSi active braze alloy.

28. The method of claim 25, wherein the first brazing material comprises nickel.

29. The method of claim 25, wherein the first brazing material comprises a low thermal conductivity metal or ceramic arranged to form a thermal barrier.

30. The method of claim 29, wherein the layer of first brazing material is in the form of a wire mesh, powder or perforated foil.
